(19) United States
(12) Patent Application Publication
(10) Pub. No.: US 2021/0247894 A1
(43) Pub. Date: Aug. 12, 2021

(54) Social Matching Games in Dating Software

(71) Applicant: Josh B. Colten, Torrance, CA (US)

(72) Inventor: Josh B. Colten, Torrance, CA (US)

(21) Appl. No.: 16/788,289

(22) Filed: Feb. 11, 2020

(51) Int. Cl. G06F 3/0484; G06Q 50/00; H04L 12/58; G06F 3/0481

(52) U.S. Cl. CPC G06F 3/04847; G06F 3/04817; H04L 51/32; G06Q 50/01

(57) ABSTRACT

A method for requesting an on-demand service for social matching games on a computing device is provided. One or more processors determine the user interaction model within a social matching game. The on-demand service is presented on the display of a computing device to provide users with information on their state within a social matching game, and to receive necessary feedback from the user to continue the process flow in order to determine a match or facilitate a conversation.

### BACKGROUND OF THE INVENTION

### Field of the Invention

This invention relates generally to social media, that may be substantially implemented via software; and more specifically to a dating software with social matching games.

### Description of the Related Art

Presently dating mobile applications (dating software) are boring and repetitive for users, often involving just liking or disliking another user. Such preexisting dating mobile applications may also provide for standard communications modes between users, such as text messaging. However, such preexisting dating mobile applications are missing ways to make interacting with the users more fun and/or more interesting. Such preexisting dating mobile applications are missing games and/or competitions between users.

There is a need in the art for a dating mobile application with games and/or game like features to add or introduce fun and/or interest into the overall dating process.

It is to these ends that the present invention has been developed.

### BRIEF SUMMARY OF THE INVENTION

To minimize the limitations in the prior art, and to minimize other limitations that will be apparent upon reading and understanding the present specification, the present invention describes computer software, specifically software commonly referred to as a “mobile application” that may be executed and/or used on a smartphone or tablet-computing device (or some other computing-device), that may be running iOS, Andriod, or some other operating system. Further, this mobile application software may be a “dating application,” that is, software to facilitate social interactions (e.g., computer aided conversations) between two or more people (users of the mobile application software) for a purpose of getting to know each other and/or to gauge compatibility between such people. Herein, this mobile application software that may be the subject of the present patent application may be termed or stylized as, “Software.” Further still, this Software may utilize one or more games. In some embodiments, at least some of these games may be termed, “Single Quest Game,” “Group Quest Game,” and “Match Quest Game.” In some embodiments, this Software may modify a computer aided conversation (e.g., text messaging) into a game or a game like experience. By adding this game or game like functionality, fun, additional fun, interest, and/or additional interest may be introduced to the dating process that is absent from other dating mobile applications. In some embodiments, this Software may allow the user who is asking a given question to specify a given Response Type format for how that given answer should be answered in. In some embodiments, the Response

Types of how a given user should respond to the questions may be selected from: text message (sms message); image with caption; video recording; voice recording; image with subtext; or the like. In some embodiments, such a video (and/or voice recording) response may be capped at certain file size and/or by time. For example, and without limiting the scope of the present invention, such a time cap may be about 15 seconds in some embodiments, wherein about in this context may be plus or minus 1 second.

It is an objective of the present invention to provide a dating mobile application.

It is another objective of the present invention to provide a dating mobile application with games between users.

It is another objective of the present invention to provide a dating mobile application that may transform an otherwise typical computer assisted conversation into a game or game like experience.

It is another objective of the present invention to provide a dating mobile application with games between users that is fun.

It is another objective of the present invention to provide a dating mobile application with games between users that is interesting.

It is yet another objective of the present invention to provide a dating mobile application with games between users that permits the users to get to know each other in a safe, fun, and/or interesting manner.

These and other advantages and features of the present invention are described herein with specificity so as to make the present invention understandable to one of ordinary skill in the art, both with respect to how to practice the present invention and how to make the present invention.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 illustrates an example method for enabling a social matching game, Single Quest, between two users.

FIGS. 2A-2H illustrate examples of user interfaces for enabling a social matching game, Single Quest, between two users.

FIG. 3 illustrates an example method for enabling a social matching game, Group Quest, between multiple users.

FIGS. 4A-4H illustrate examples of user interfaces for enabling a social matching game, Group Quest, between multiple users.

FIG. 5 illustrates an example method for enhanced communication between two matches.

FIG. 6 illustrates an example user interface for enabling an enhanced communication between two matches.

FIG. 7 is a block diagram of a networked computing system upon which embodiments described herein may be implemented.

FIG. 8 is a block diagram that illustrates a mobile computing device upon which embodiments described herein may be implemented.

### DETAILED DESCRIPTION

The embodiments herein describe methods and systems for complementing dating applications with social matching games. These social matching games enable users to interact with other users, in an interactively complex way through on-demand services using a computing device.

It is noted that user interfaces for web and mobile applications are well known in the art, as well as controls for user interactions. User interface controls come in a variety of designs, and generally allow users to interact by allowing for input, selection, navigation, and information.

Methodology

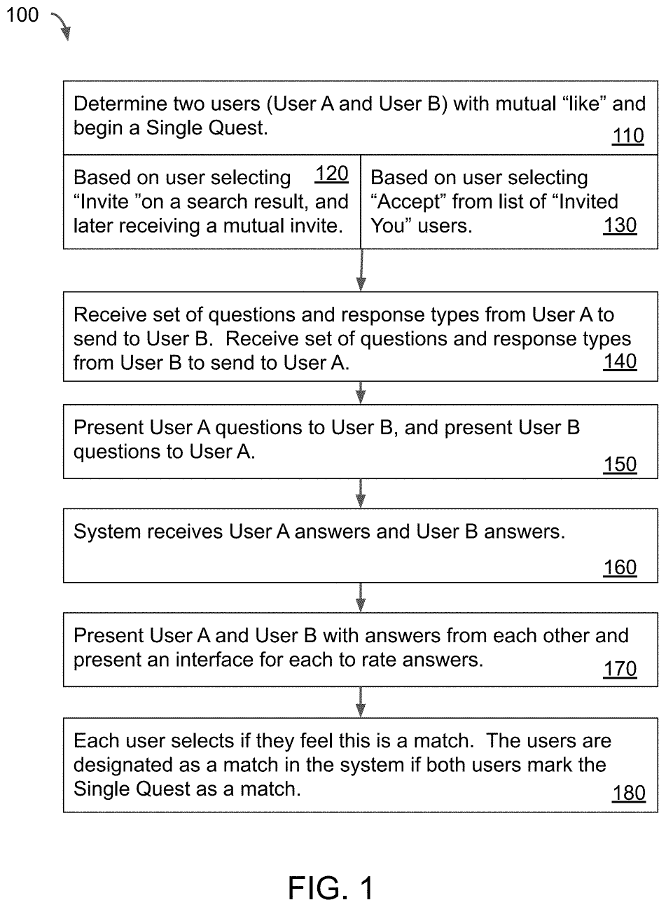

FIG. 1 illustrates an example method for enabling a social matching game between two users. In one embodiment, the social matching game is called Single Quest. This social matching game operates off an on-demand computing model, wherein users can interact with the on-demand system at their convenience, and interact with rich dynamic data that can be real-time or near real-time.

Based on previous interactions by users in Single Quest, the on-demand system can determine two users who have mutually marked each other as “Invite” (step 110). The marking of “Invite” is a tagging methodology, in which users view other users, and mark them with a “Invite” property. If two users mutually mark each other with the “Invite” property, then they qualify to interact with each other within the Single Quest process. This may happen based on a user marking someone as “Invite”, and the mutual “Invite” from the correlated user occurring at some later time (sub-step 120). This may also happen based on a user viewing which other users have marked him or her as “Invite”, and for the user to mutually “Invite” someone back (sub-step 130).

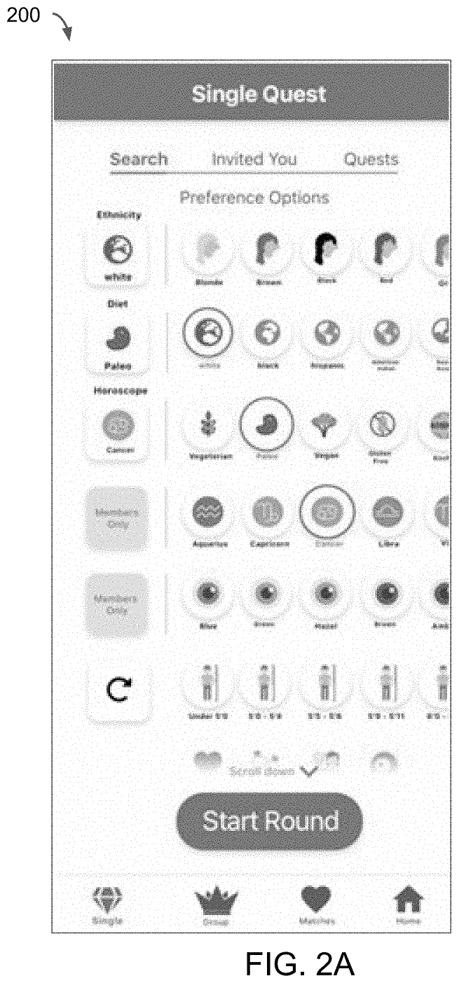

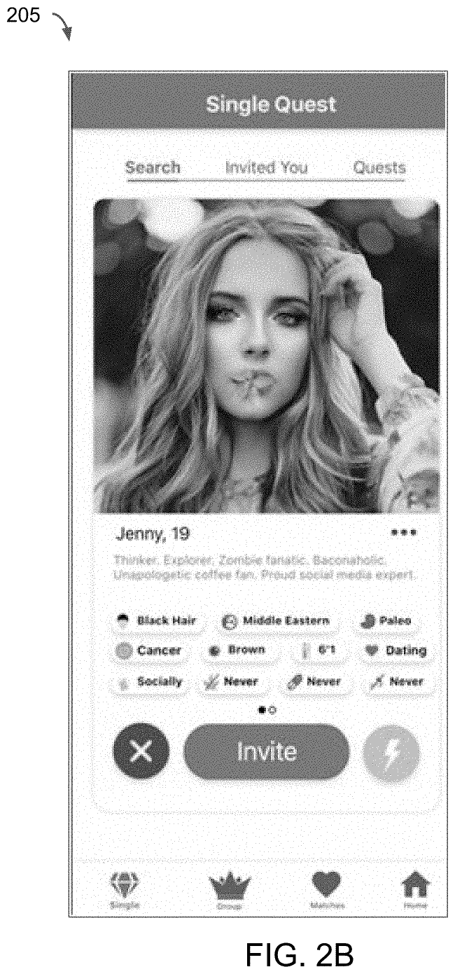

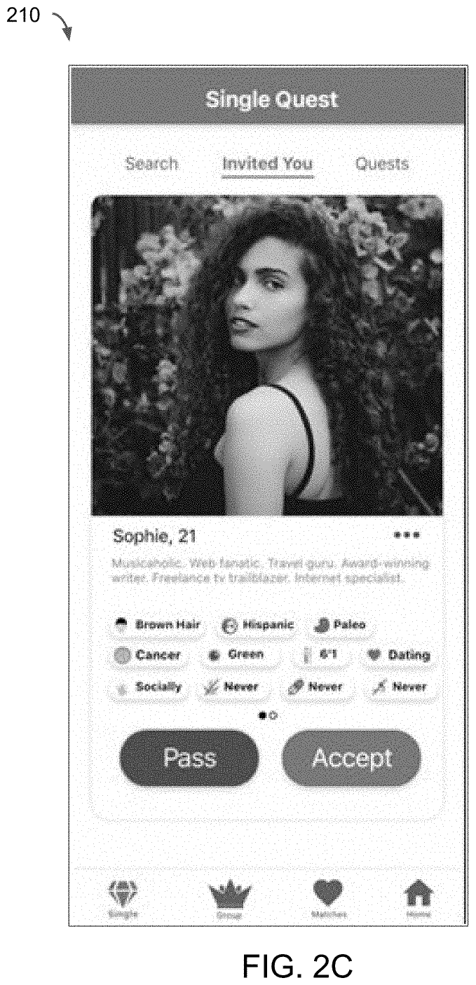

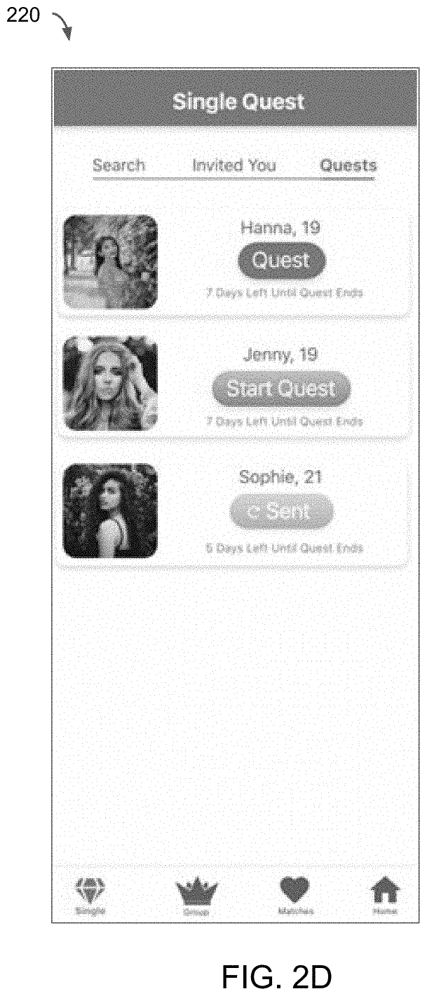

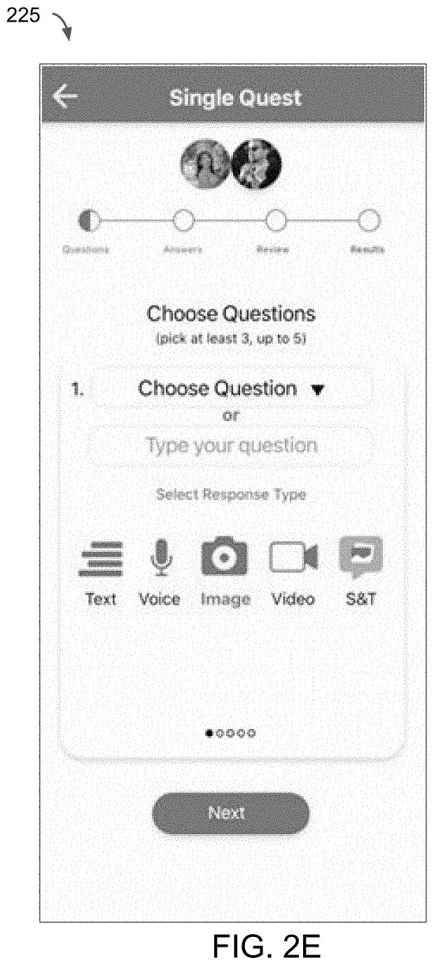

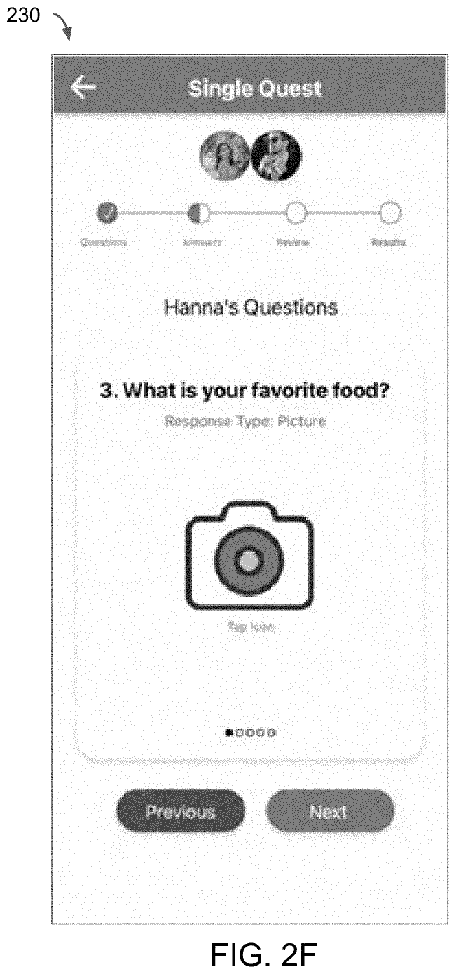

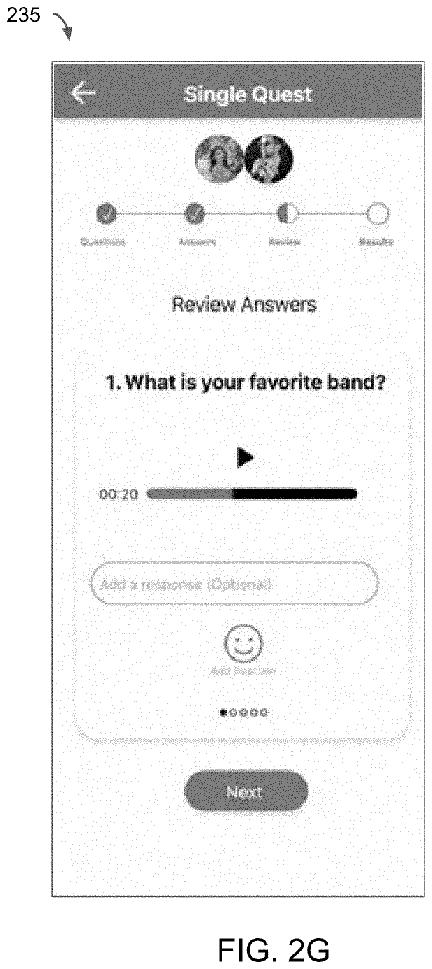

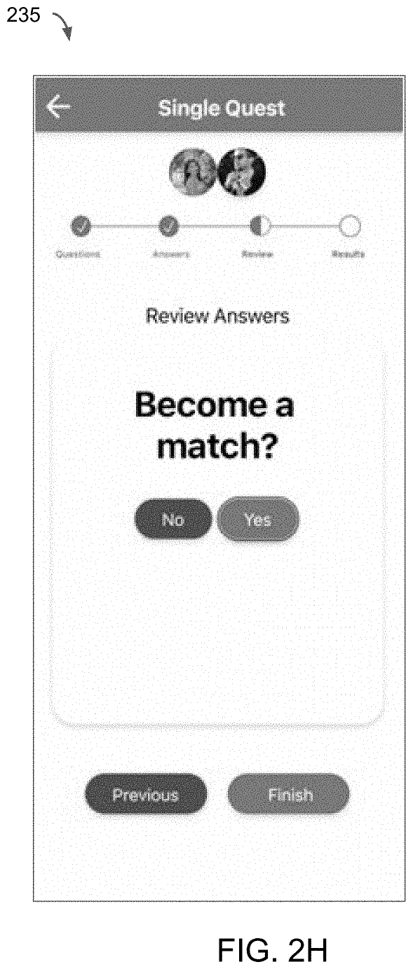

FIG. 2A illustrates an example user interface in which a user may visually select preferences for finding other users. The system will return search results based on the selected preferences, and possibly other logic, such as geographic distance range and age range. From the search results, the user determines who they would like to mark as “Invite.” In some embodiments, the user may be given the ability to mark someone as “Pass.” The Pass property can be stored by the on-demand system to avoid presenting those users again. In one embodiment, the on-demand system will show five user results, and allow the user to see details about each user from the search results. FIG. 2B illustrates an example user interface showing details of a user from the search results.

FIG. 2C illustrates an example user interface where a user can see individuals that have marked him/her with a “Invite.” In this embodiment, the user can mutually invite them back (sub-step 130) by selecting “Accept.”

Once the on-demand system has determined a Single Quest pairing between two users (User A and User B), the system can start a fun and engaging, interaction model between the user pair. In some embodiments, both users within the Single Quest pairing will need to explicitly initiate the Single Quest to begin. FIG. 2D illustrates an example user interface wherein a user can see all Single Quests they are involved in. As illustrated in FIG. 2D, the on-demand system displays Single Quests that fall within three different states: a) Single Quest has started and is in progress, b) user has not explicitly initiated the Single Quest, and c) user has explicitly initiated the Single Quest, but the paired user has not.

Each user participates in this interaction model by specifying a series of questions (step 140). The number of questions may vary, and in some embodiments, anywhere from 1 to 10 questions are allowed. The users may specify a question by inputting it in a free form text field.

In some embodiments, the users may select from a list of pre-generated questions recommended by the on-demand system. The list of available pre-generated questions may be constructed in a variety of ways by the on-demand system. Most simply, the on-demand system may have a list of static questions that it may retrieve from its data storage. Or the on-demand system may suggest previous asked questions by User A or other users. Or also, the on-demand system may use AI to generate new questions that are relevant to the user pair, based on their profile and any other data about those users.

In some embodiments, the user also specifies a response type for each question. The response types define what type of response format the user prefers, such as, but not limited to, text, link, multimedia story, voice (audio), picture, video, emoji, song, or some combination. For any audio, video, and still photo needs, the user may utilize the camera and/or microphone on their computing device to generate these responses.

FIG. 2E illustrates an example user interface for choosing a question and response type. A question set is defined as a multitude of question and response type pairs.

After the on-demand system has received the series of questions, and optionally the response types, from both users, the on-demand system will proceed to notify and present the questions to each user (step 150). User A is presented with questions from User B, and vice versa. The on-demand system allows each user to input answers to the questions, possibly within the guidelines of the response type (step 160). FIG. 2F illustrates an example user interface where User B is allowed to answer a question within the guidelines of the response type. The series of answers to the series of questions is called an answer set.

Once the answers are completed by both users, both users are notified and presented with the completed answers from the other party. The users review the answers, and may mark a comment or visual reaction to the answer. FIG. 2G illustrates an example user interface for this step (170). In one embodiment, the on-demand system tracks which answers are marked with a positive reaction and will tally these. The on-demand system may present the tally back to both users. The on-demand system will determine whether the pair is a match or not based on the tally of positive reactions to the answers. If 50% or more of the answers received a positive reaction, and this is true for both users, then the system will designate the pair as a match. In another embodiment, the users may select whether to become a match or not after reviewing all of the answers (step 180). If both mutually select to become a match, then the on-demand system will designate them as a match. FIG. 2H illustrates an example user interface in which the users can make the match determination.

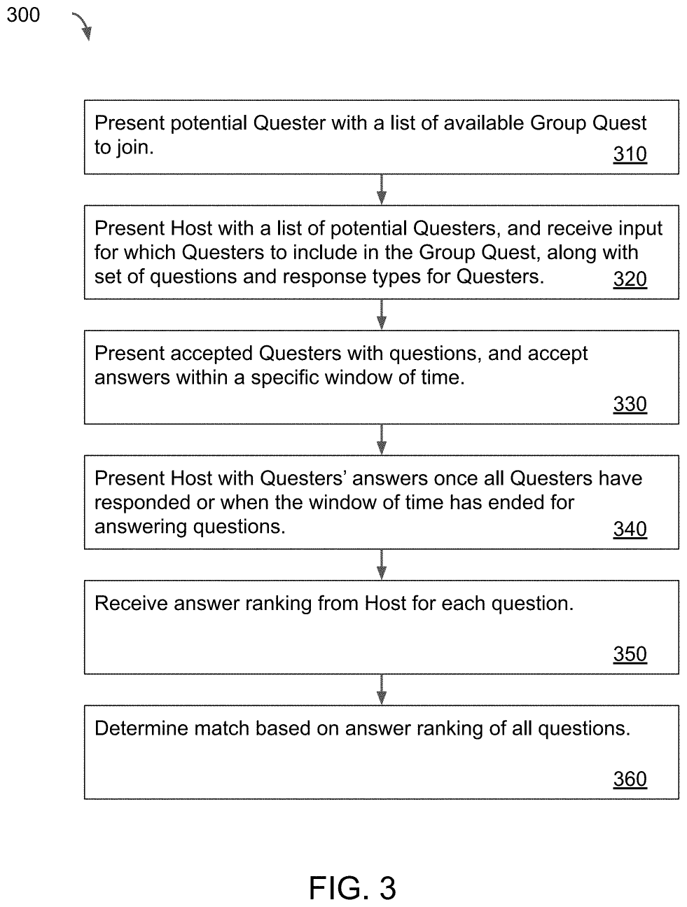

FIG. 3 illustrates an example method for enabling a social matching game between a Host and multiple Questers. In this embodiment, the social matching game is called Group Quest. This social matching game operates off an on-demand computing model, wherein users can interact with the on-demand system at their convenience, and interact with rich dynamic data that can be real-time or near real-time.

Each Group Quest begins by having a user initiate a new Group Quest instance, and this user is known as the Host. Multiple other users may participate in a Group Quest with the Host, and they are referred to as Questers. The goal of Group Quest is to find one or more matches for the Host with the Questers.

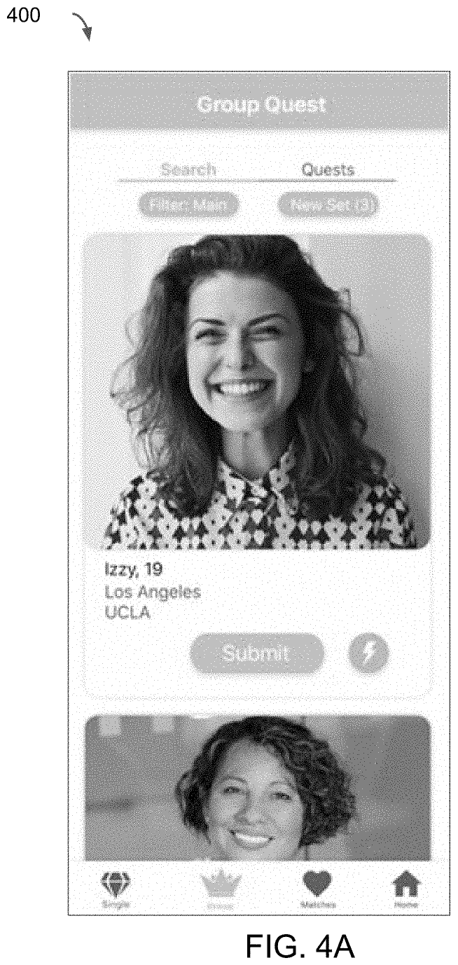

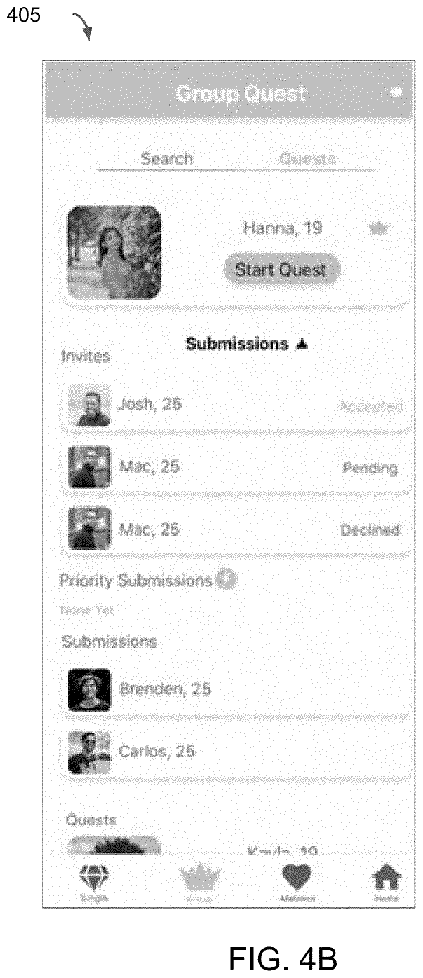

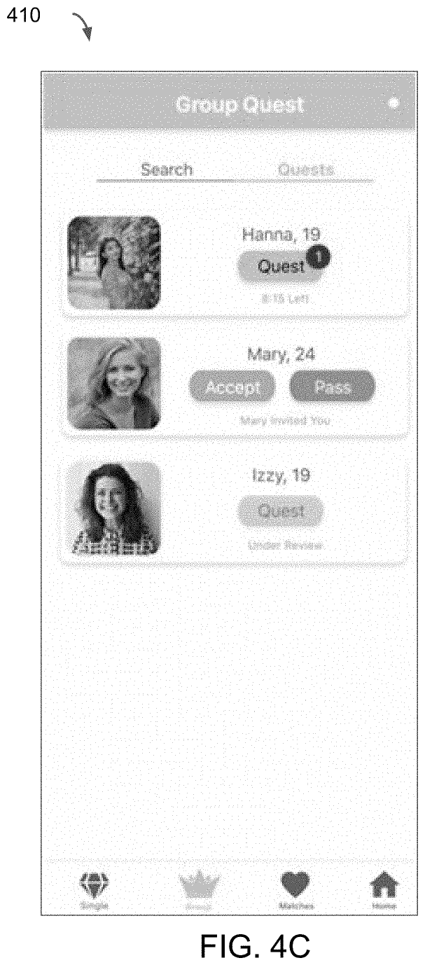

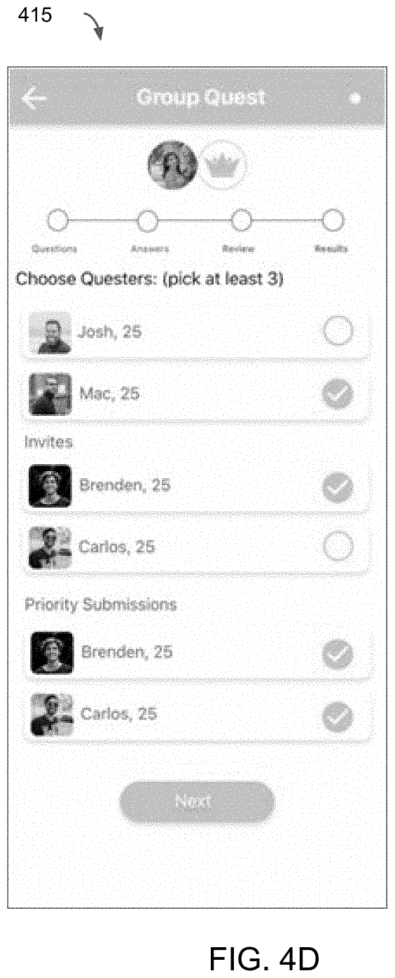

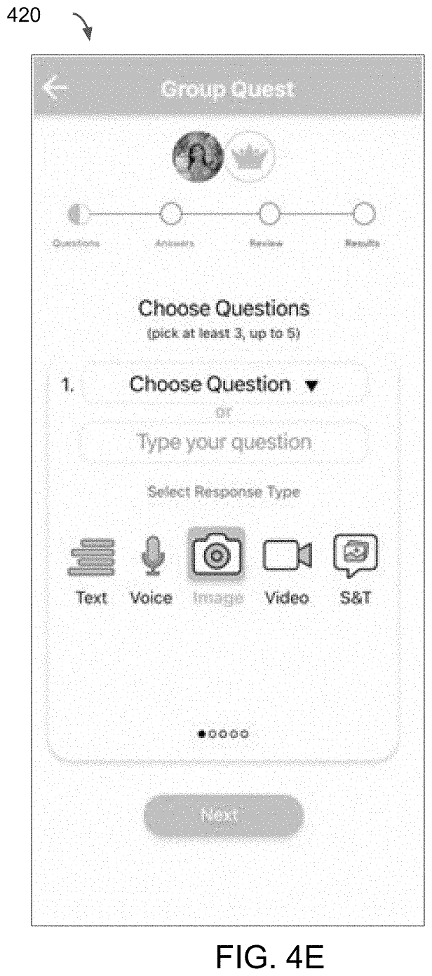

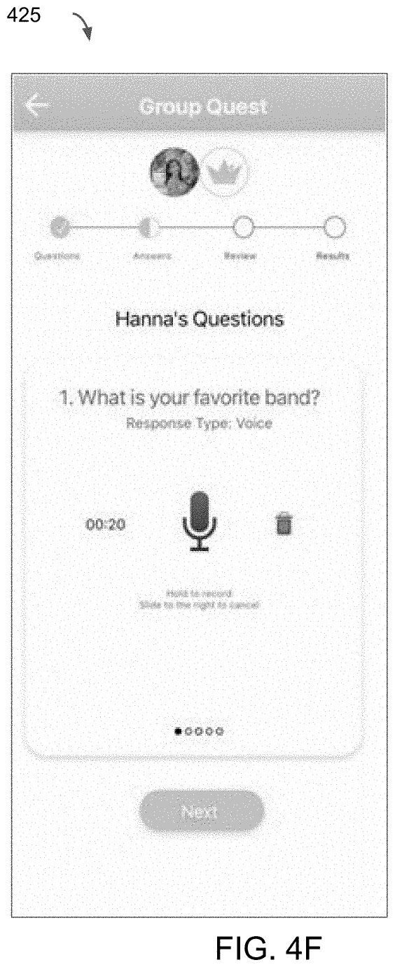

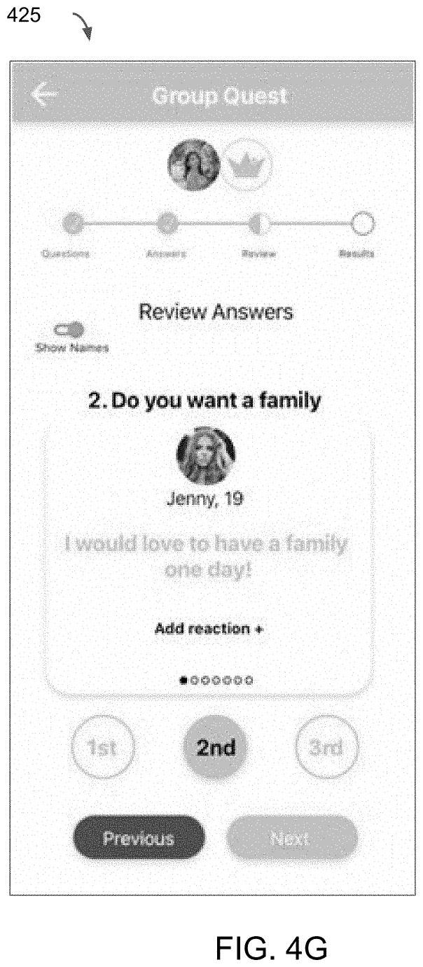

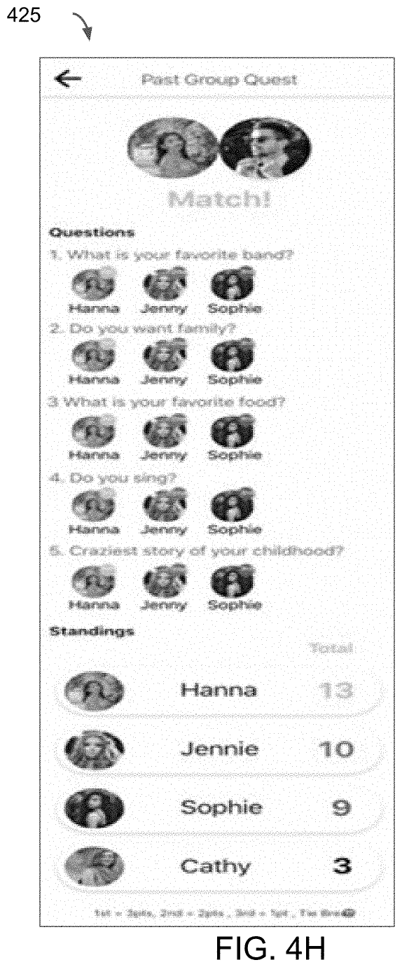

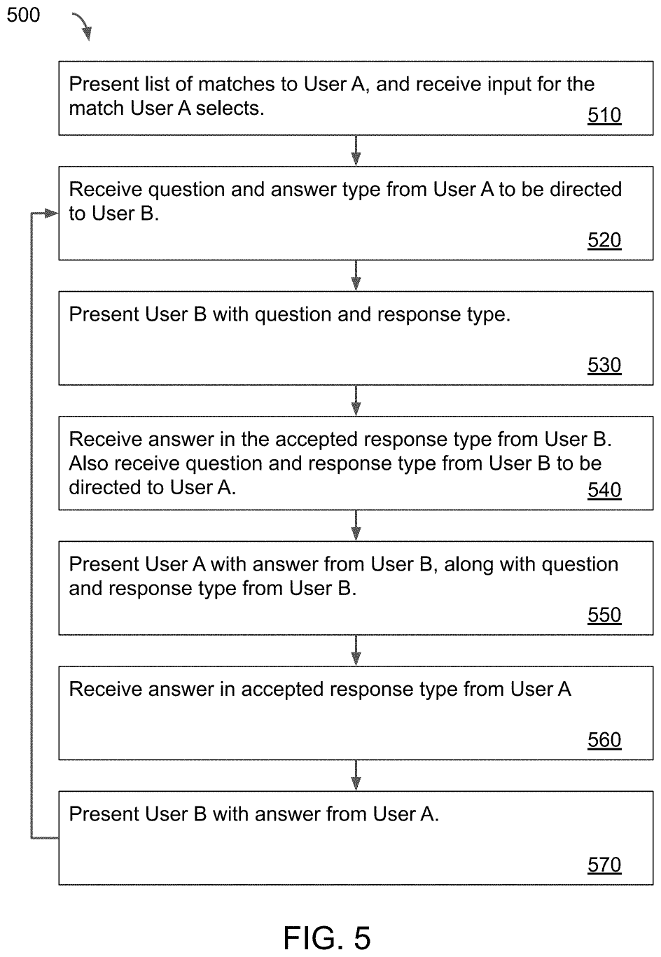

From previous interactions with the users in the system, the on-demand system is able to determine a list of available Group Quests instances. In step 310, a user may search for available Group Quests, which the on-demand system will return based on the previously mentioned data, and may also employ other logic such as geographic distance range and age range for determining what to return in the search results. FIG. 4A illustrates an example user interface for showing a list of available Group Quests, which in effect shows the Host since there is a one to one association between a Group Quest and a Host. The user is able to initiate a request to join a Group Quest, making the user a Potential Quester for that Group Quest instance. In some embodiments, the Host may also search for users to invite to join the Group Quest.

In step 320, the on-demand system compiles a list of Potential Questers for a particular Group Quest, and displays this list to the Group Quest Host. FIG. 4B illustrates an example user interface that the Group Quest Host utilizes for seeing the current participant list for a Group Quest. The Host is able to see the statuses of users invited to the Group Quest, and users that are requesting to participate in the Group Quest.

In some embodiments, the number of users allowed to submit a request to join a particular Group Quest may be capped. Once the cap is reached, the Group Quest may not accept additional requests and may no longer display in the search results. The Host may select which users are allowed to participate in the Group Quest (step 320). In some embodiments, the number of Questers that may be selected may be controlled with a minimum and maximum, such as between 2 and 10. FIG. 4D illustrates an example user interface for the Host to select who will be the Questers in the Group Quest from the available list of users.

Once the participants are selected, the Host may start the Group Quest and designate a set of questions for the Questers to answer. The number of questions may vary, and in some embodiments, anywhere from 1 to 10 questions are allowed. The Host may specify a question by inputting it in a free form text field.

In some embodiments, the Host may select from a list of pre-generated questions recommended by the on-demand system. The list of available pre-generated questions may be constructed in a variety of ways by the on-demand system. Most simply, the on-demand system may have a list of static questions that it may retrieve from its data storage. Or the on-demand system may suggest previous asked questions by the Host or other users. Or also, the on-demand system may use AI to generate new questions that are relevant to the Host and set of Questers, based on their profile and any other data about those users.

In some embodiments, the user also specifies a response type for each question. The response types define what type of response format the user prefers, such as, but not limited to, text, link, multimedia story, voice, picture, video, emoji, song, or some combination.

FIG. 4E illustrates an example user interface for the Host to choose the questions and response types. A multitude of questions and their associated response type is called a question set. In one embodiment, the on-demand system will allow the Host to choose 5 to 7 questions, and all Questers will receive the same questions with a 24 hour time limit to respond. In Step 330, all the Questers are presented with the same question set, and given an opportunity to provide answers. FIG. 4F illustrates an example user interface for Questers to provide their answers. In FIG. 4F, the response type is designated as audio, and an audio recording is performed directly from the computing device for the answer. When a Quester provides answers to all the questions in a question set, that is called an answer set.

In Step 340, the Host is presented with the opportunity to review all of the answers provided by the Questers. In one embodiment, this step begins when all answers have been finalized or when the time window for responding has expired.

In Step 350, the Host reviews the answers, and the on-demand system facilities a Quester ranking system by allowing the Host to provide feedback across Questers for each question. In one embodiment, the on-demand system allows the Host to rank the plurality of answers as 1st, 2nd, or 3rd place. The on-demand system will assign 3 points for 1st place answers, 2 points for 2nd place answers, and 1 point for 3rd place answers. FIG. 4G illustrates an example user interface for assigning such a ranking. Once all answers have been reviewed and ranked, in Step 360, the on-demand system will tally the scores and present them to the host. The winning Quester becomes a match with the Host. FIG. 4H illustrates an example user interface showing the tally of points for the completed Group Quest.

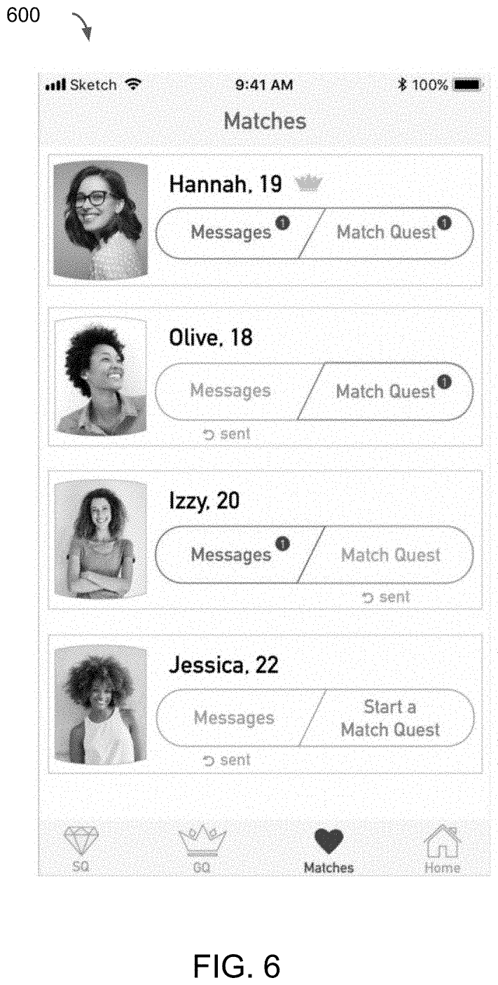

In a traditional dating application, once two users are matched, they are allowed to communicate directly by sending messages to one another through the dating application. Just as the on-demand system enhanced the the matching process through social matching games, the matched communication process can be enhanced through the use of an on-demand system for more complex and rich interactions amongst the matched users. In one embodiment, a matched communication game known as Match Quest is provided by the on-demand system. FIG. 6 illustrates an example user interface where a user can see a list of matches they can communicate with, and can start a Match Quest. The Match Quest method 500 starts with a first user being presented with a list of matches, and the on-demand system receiving an input from the first user on which match to communicate with via Match Quest (step 510). The on-demand system will then identify a question and response type to be sent to the matched user, on behalf of the first user (step 520). The question may be identified by having the first user input a custom question, having the first user select from a list of pre-generated questions, or by having the on-demand system automatically select a pre-generated question for the first user.

Pre-generated questions are generated by the on-demand system. In one embodiment, the pre-generated questions are retrieved from a list of manually programmed, static questions from its data storage. In another embodiment, a pre-generated question may be a question previously asked by the first user to other matches. In yet another embodiment, pre-generated questions may be generated by the on-demand system using AI to come up with questions that are relevant to the matched pair, based on their profile and any other data about those users.

The question is presented to the matched user, along with the preferred response type (step 530). The on-demand system may only allow the matched user to respond using the preferred response type. In some embodiments, the matched user is allowed to override the preferred response type within the on-demand system, and respond with a different response type. The on-demand system will also give the matched user an opportunity to identify a question and preferred response type to be sent back to the first user on behalf of the matched user (step 540).

In the next step, 550, the first user is presented with the answer from the matched user, along with a question and preferred response type. In step 560, the first user may respond to the question from the matched user, which will ultimately be presented back to the matched user in step 570. In addition, the first user may repeat the process by asking another question (step 520).

In another embodiment of Match Quest, the on-demand system may use a pre-generated question to send to both users within a match, along with a preferred response type. Both users will have the ability to respond with the preferred response type, and in some embodiments, may override the preferred response type and use a different response type. Once both users have completed answering, the on-demand system will make the responses available for viewing for both users. Then, either user can request for the on-demand system to repeat the process.

System Description

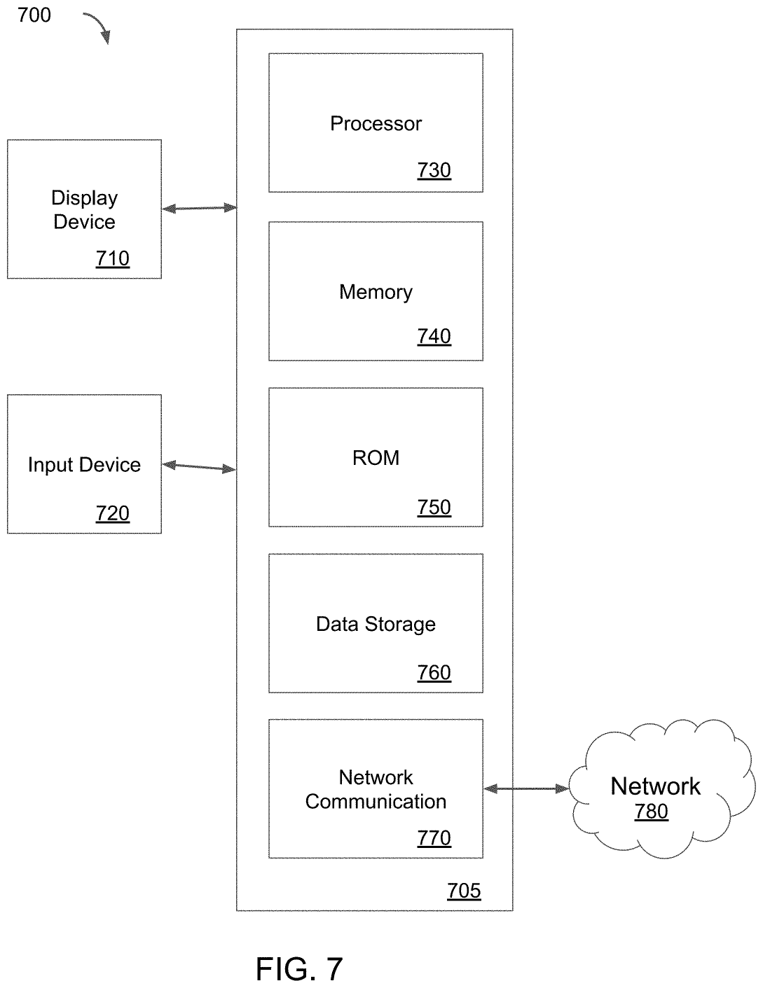

FIG. 7 is a block diagram that illustrates a computing system upon which embodiments described herein may be implemented. In one embodiment, FIG. 7 may correspond to a server, such as a physical server or a virtualized system. Computing system 700 includes a processor 730, memory 740, a display device 710, input device 720 (such as a keyboard, touch screen, mouse, voice, camera or trackpad), ROM 750, data storage 760, and network communication 770.

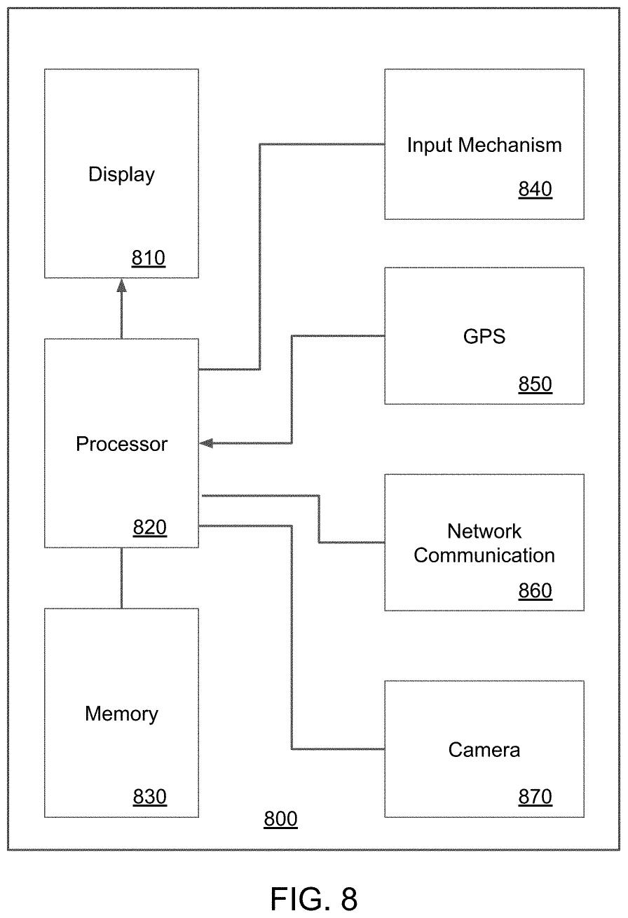

FIG. 8 is a block diagram that illustrates a computing device 800 upon which embodiments described herein may be implemented. In one embodiment, computing device 800 corresponds to a mobile computing device, such as a cellular device that is capable of telephony, messaging, and data services. Examples include smartphones, handsets, wearables, or tablet devices. Computing device 800 includes a processor 820, memory 830, display 810, input mechanism 840 (can include a touch screen display device), GPS 850, network communication 860, and camera 870.

The computing system 700 may be a server that communicates with computing device 800. In a preferred embodiment, computing device 800 communicates and jointly processes information with computer system 700 to operate the on-demand services as described in methods 100, 300, 500, and other methods described above. The advantages of combining a computing system 700 with a computing device 800 includes the ability to store data on the server-side, which allows a user to switch computing devices and gain access to the same level of on-demand service across all computing devices. Another advantage of using a computing system 700 with a computing device 800 is the ability for a computing system 700 to handle heavier processing and more efficient processing for logic that requires data from multiple users.

The computing system 700 and computing device 800 are configured with software, or logic operations to perform one or more processes or implementing the method and user interface in the application. The processor 730 820 is configured with instructions and data stored in the memory 740 830 to operate on-demand service application as described in the application. The processor 730 820 can cause user interface features to be presented on the display 710 810 by executing instructions that are stored in the memory 740 830. As an example, user interfaces FIGS. 2A-2H can be provided by the processor 820 based on user input and/or selections received from the user. In some implementations, the user can interact with a touch-screen display device 810 to make selections on the different user interface features.

Although the present invention has been described in detail with respect to certain embodiments and examples, variations and modifications exist which are within the scope of the present invention as defined in the following claims.

1. A method for providing an on-demand service on a first computing device and second computing device, the method being performed by one or more processors comprising:
determining a first user, on said first computing device, and second user, on said second computing device, qualified for connecting in a social matching game;
receiving a first user input to start the social matching game with said second user and second user input to start the social matching game with said first user;
in response to receiving the first and second user inputs to start the social matching game, providing, on a display of the first computing device and second computing device a user interface to input a first question set and second question set respectively, the question sets comprising of a plurality of question and preferred response type pairs, wherein the preferred response type is selected from a set of two or more available response types;
receiving the first question set from the first user and the second question set from the second user;
in response to receiving the definitions for the first question set and second question set, providing, on the display of the first computing device the second question set and on the display of the second computing device, the first question set;
receiving a second user answer set correlating to the first question set from the second computing device and receiving a first user answer set correlating to the second question set from the first computing device, wherein the answer sets are answers to the plurality of questions in the preferred response type for each question; and
determining if the first user and second user are a match based on the first user answer set and second user answer set.

2. The method of claim 1 wherein the available response types comprise of text, audio recording, video recording, and photo.

3. The method of claim 2 wherein step of determining a first user and second user qualified for connecting in a social matching game further comprising:
providing, on a display of the first computing device, a user interface for selecting a plurality of user search preference criteria, wherein each user search preference criteria represents visual icons available for selection;
receiving the plurality of selection for the user search preference criteria from the first user;
generating a search result of users based on the plurality of selection for the user search preference criteria;
receiving a request from the first user to initiate the social matching game with the second user, wherein the second user is contained within the search result of users; and
receiving a request from the second user to initiate the social matching game with the first user.

4. A method for providing an on-demand service on a plurality of computing devices, the method being performed by one or more processors comprising:
determining a Host and a plurality of Potential Questers for participation in a social matching game;
receiving a Host user input to select two or more of the plurality of Potential Questers to become a plurality of Questers in the social matching game;
in response to receiving Host user input, starting the social matching game with the Host and plurality of Questers, and providing, on the display of a Host computing device, a user interface to provide options for defining a question set, the question set comprising of a plurality of question and preferred response type pairs, wherein the preferred response type is selected from a set of two or more available response types;
providing, on the display of a plurality of computing devices for the plurality of Questers, a user interface showing the question set and controls for answering each of the plurality of questions in the preferred response type;
receiving at least two answer sets from the plurality of Questers, wherein an answer set comprises of a plurality of answers corresponding to the plurality of question and response type pairs;
providing, on the display of the Host computing device, a user interface with the first answer set and second answer set, and controls for scoring the plurality of answers of the first answer set and plurality of answers from the second answer set; and
determining a match between the Host and at least one of the plurality of Questers based on a tally of said scoring.

5. The method of claim 4 wherein the available preferred response types comprise of text, audio recording, video recording, and photo.

6. The method of claim 5 wherein step of determining a Host and a plurality of potential users for participation in a social matching game further comprising:
receiving a request from the Host to initiate the social matching game as a host; and
providing, on the display of a plurality of computing devices for a plurality of users, a user interface listing at least the social matching game instance associated with the Host and controls for selecting to become a Potential Quester.

7. A non-transitory computer-readable medium storing instructions that, when executed by one or more processors of a computing system, cause the computing device to perform operations comprising:
determining a first user and second user qualified for connecting in a social matching game;
receiving a first user input and second user input to start the social matching game;
in response to receiving the first and second user inputs to start the social matching game, providing, on a display of the first user computing device and second user computing device a user interface to provide options for defining a first question set and second question set respectively, the question sets comprising of a plurality of question and preferred response type pairs, wherein the preferred response type is selected from a set of two or more available response types;
receiving the first question set from the first user and the second question set from the second user;
in response to receiving the definitions for the first question set and second question set, providing, on the display of the first user computing device the second question set and on the display of the second user computing device, the first question set;
receiving a second user answer set correlating to the first question set from the second user computing device and receiving a first user answer set correlating to the second question set from the first user computing device, wherein the answer sets are answers to the plurality of questions in the preferred response type for each question; and
determining if the first user and second user are a match based on the first user answer set and second user answer set.

8. The non-transitory computer-readable medium of claim 7 wherein the available response types comprise of text, audio recording, video recording, and photo.

9. The non-transitory computer-readable medium of claim 8 wherein step of determining a first user and second user qualified for connecting in a social matching game further comprising:
providing, on a display of the first user computing device, a user interface for selecting a plurality of user search preference criteria, wherein each user search preference criteria represents visual icons available for selection;
receiving the plurality of selection for the user search preference criteria from the first user;
generating a search result of users based on the plurality of selection for the user search preference criteria;
receiving a request from the first user to initiate the social matching game with the second user, wherein the second user is contained within the search result of users; and
receiving a request from the second user to initiate the social matching game with the first user.

10. The method of claim 3 wherein said user interface to input the first question set and second question set is further comprised of an input for defining each question, with the choice of both a free form text input and a list of pre-generated questions.

11. The method of claim 10 further comprising:
displaying the second user answer set to the first user and the first user answer set to the second user;
receiving from the first user a reaction to each of the answers in the second user answer set, and receiving from the second user a reaction to each of the answers in the first user answer set, wherein at least one of the first user's reaction is positive and at least one of the second user's reaction is positive; and
determining if the first user and second user are a match based on the count of positive reactions from the first user and the second user.

12. The method of claim 6 wherein said user interface to input the question set is further comprised of an input for defining each question, with the choice of both a free form text input and a list of pre-generated questions.

13. The method of claim 12 wherein the answer set submitted by the plurality of Questers is accepted if submitted by the Quester within a defined time limit.

14. The method of claim 13 wherein the controls for scoring the plurality of answers further comprising the Host designating a 1st place Quester answer, 2nd place Quester answer, and 3rd place Quester answer for each of the questions.

15. The non-transitory computer-readable medium of claim 9 wherein the user interface to input the first question set and second question set further comprising an input for defining each question, with the choice of both a free form text input and a list of pre-generated questions.

16. The non-transitory computer-readable medium of claim 15 further comprising:
displaying the second user answer set to the first user and the first user answer set to the second user;
receiving from the first user a reaction to each of the answers in the second user answer set, and receiving from the second user a reaction to each of the answers in the first user answer set, wherein at least one of the first user's reaction is positive and at least one of the second user's reaction is positive; and
determining if the first user and second user are a match based on the count of positive reactions from the first user and the second user.
